(19) United States
(12) Patent Application Publication
(10) Pub. No.: US 2005/0167536 A1
(43) Pub. Date: Aug. 4, 2005

(54) Cutting machine for organic plant materials, especially for tobacco

(75) Inventor: Jerzy W. Chojnacki, Radom (PL)

Correspondence Address: DARBY & DARBY P.C., P. O. BOX 5257, NEW YORK, NY, 10150-5257, US

(73) Assignee: International Tobacco Machinery Poland Ltd., Radom (PL)

(21) Appl. No.: 10/511,965

(22) PCT Filed: Dec. 19, 2002
(86) PCT No.: PCT/PL02/00106

(30) Foreign Application Priority Data
May 8, 2002 (PL) P 353 760

(51) Int. Cl. B02C 1/08

(52) U.S. Cl. 241/223

(57) ABSTRACT

The invention relates to a cutting machine for organic plant materials, especially for tobacco, which comprises a cutting head mounted inside a main frame, and a feeding-compacting arrangement frame forming a stream of the fed material, comprising transporters feeding the material into a cutting zone, and means for compacting and/or polarizing relative distribution of fed particles. The cutterhead (2) of the cutting machine is mounted in a stationary main frame (1) fixed preferably to the floor, and the feeding-compacting arrangement frame (5) is moved along the horizontal guides (7). The cutting head 82) is a cutterhead with the main axis of rotation being horizontal.

This invention relates to a cutting machine for organic plant materials, especially for tobacco.

Feed material for the cutting machine is tobacco in any of various forms, e.g., including leaves or parts thereof, veins of tobacco leaves, tobacco foils, cigar fillings, cut tobacco, trimmings and/or crumbs, and any combination of tobacco comprising materials in any form. It is recommended to process the tobacco material prior to feeding it to the cutting machine so that moisture content in the fed material is uniform for the whole portion at the level of at least 13-14% by weight, suitably at least 16% by weight, preferably more than 19% by weight. Details of the above mentioned processes for increasing humidity are known and used in the art.

Moistened tobacco is fed to a feeding device/conveyor of the cutting machine by means of any known technique, most commonly by means of a conventional method, known in tobacco processing technology. An exemplary process for tobacco processing may be carried out according to patent application U.S. Pat. No. 5,722,431.

The cutting machine operation results in tobacco (product); for instance cut tobacco, cut and/or comminuted, according to requirements and technological parameters.

From DE 10021614 a cutting machine is known in which the frame of a cutterhead and main frame of the machine are joined by a hinge, which allows the cutterhead frame to be partially turned or deflected, the main frame of the machine being attached to the base. In this solution a method is presented as well as a device for automatic sharpening of tobacco cutting knives.

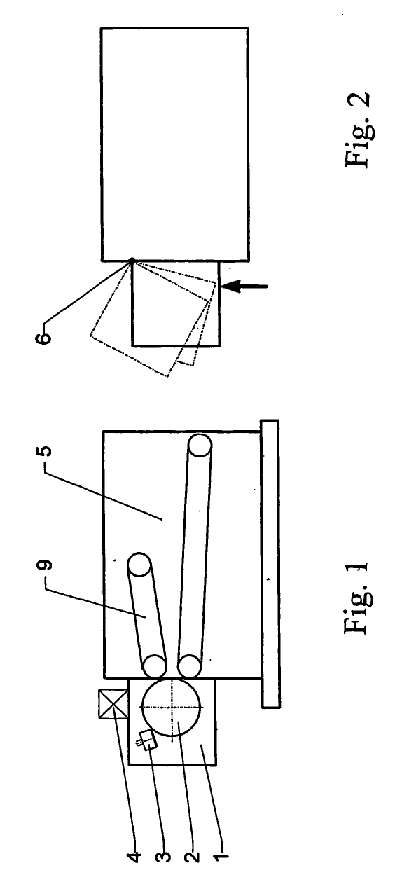

Known cutting machines for organic plant materials, especially for tobacco, presented in FIG. 1 and FIG. 2 as a side view and a plan view respectively, comprise of a cutterhead 2 fixed in a main frame 1, and a frame 5 of a feeding-compacting arrangement forming a stream of the fed material, the arrangement being provided with transporters 9 for feeding the product into the cutting zone and means for compacting and/or polarising relative distribution of fed particles. The main frame 1 and the frame 5 of the feeding-compacting arrangement forming the stream of the fed material are attached to each other by means of the hinge 6 which allows the cutterhead frame to be partially turned thus opening an access to the cutting knives as well as to the material fed to the cutting zone, including the mouthpiece which crushes and forms the material to be cut/comminuted.

The cutterheads 2 most frequently have a diameter of 600 mm. These cutterheads are provided with cutting knives, which are sharpened by means of a grinding machine 3. The revolution of the cutterhead is generated by an electric motor 4.

There is only a limited access to the cutterhead and parts thereof in known cutting machines, making impossible both convenience and safety during maintenance of the device. For users it is a disadvantageous solution because of difficult and dangerous access to the zone of replacement of the cutting knives and to cutting zone, where a person maintaining the machine contacts directly sharp and uncovered cutting knives of the cutterhead, the access to the serviced parts being difficult and one-sided.

The cutting machine for organic plant material, especially for tobacco, according to the invention is characterized in that the cutterhead is mounted in a stationary main frame, preferably attached to the base, and the feeding-compacting arrangement frame is moved along the horizontal guides.

The cutting head is a cutterhead with the main axis of rotation being horizontal, preferably the cutterhead being provided with a number of cutting knives symmetrically arranged around its perimeter, the number being divisible by 2, 4, 8 or 16.

The cutting knives have cutting edges situated at an angle delta relatively to the horizontal direction during cutting/comminuting operation.

The distance between the lower knife edge of the mouthpiece and the surface of a cylinder described by the cutting edges of the cutting knives of the cutterhead is almost zero.

Moreover, the angle delta remains in the range from 0° to 15°, preferably from 0° to 10°.

The guides are provided over the feeding-compacting arrangement frame.

The cutting machine is provided with an integral control system.

The main frame is provided with guarding to the cutting edges of the cutting knives.

In the cutting machine according to the invention, optimal, full, safe and direct access from the floor/base level to all operational zones and modules of the cutting machine is achieved, which affect the way and quality of operation of the device, particularly a directly and easily accessible maintenance-servicing space formed after removing a moveable frame comprising conveyor(s) feeding and/or forming a stream of tobacco from the stationary frame, comprising the cutterhead, to the cutting/comminuting zone. By means of this feature significant facilitation, improvement and rationalization of all, periodically carried out operations for correct, failure-free operation of the cutting machine are achieved.

According to the invention the main part of the cutting machine is a rotary cutterhead placed in a stationary frame, and devices feeding the material in any way, into a cutting zone are moved therefrom along guides, preferably the guides being placed high, i.e., at such a height so as to make it possible safe and full access to the cutting zone (cutting knives, cutterhead and the mouthpiece), the devices thereby not being attached to the cutterhead frame permanently, for example by means of a hinge, having separable points of mechanical coupling (fastening) only, allowing desired, advantageous, unequivocal positioning of all arrangements during operation.

The rotary drum of the cutterhead is of specific design, resulting from an analytical optimisation of strength parameters in dynamic and heat load conditions, and allowing maintaining predetermined cutting/comminuting parameters with modified, as compared with conventional, geometry of cutting, including a modified geometry of the cutter, a modified path of the cutter blade and thereby a modified character of the cutter operation in the cutting/comminuting zone.

As a consequence of the applied innovations the machine achieves better cutting results of the organic material and allows for significant simplification of maintenance and servicing of the machine.

In order to achieve assumed quality parameters of the cut product, for example cut tobacco, significantly lower forces are needed, deforming and compressing tobacco in the cutting/comminuting zone thereby significantly improving the above mentioned quality parameters of the final product from the cutting machine, thus much better results of cutting are obtained with the cutting machine according to the invention.

The embodiment of the invention will be described with reference to the accompanying drawings, in which:

FIGS. 1 and 2 is a simplified side view illustrating the known cutting machine,

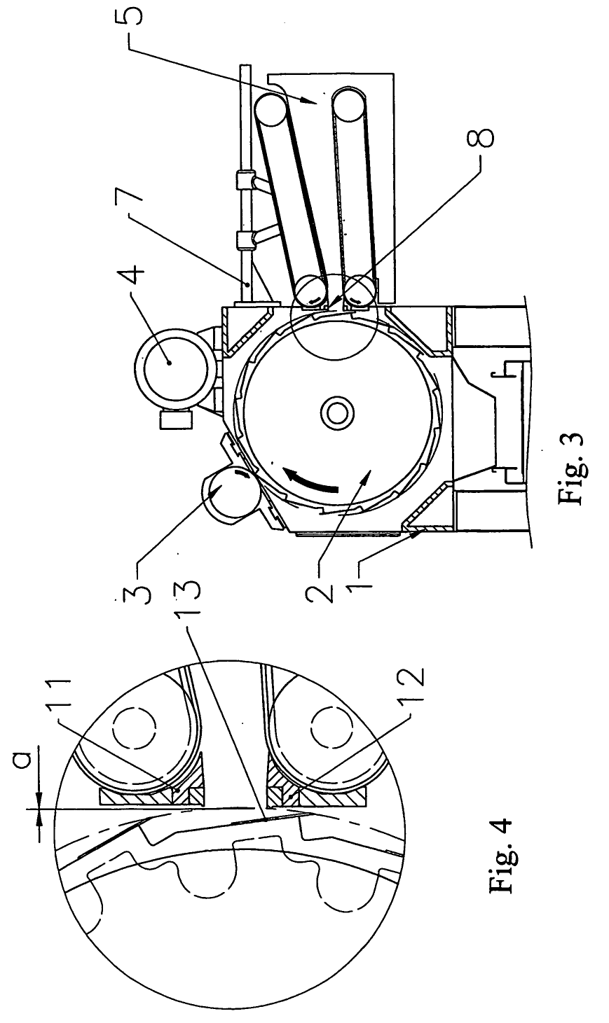

FIG. 3 is a simplified side view illustrating the cutting machine after removing shield elements,

FIG. 4 presents enlarged, marked detail of FIG. 3,

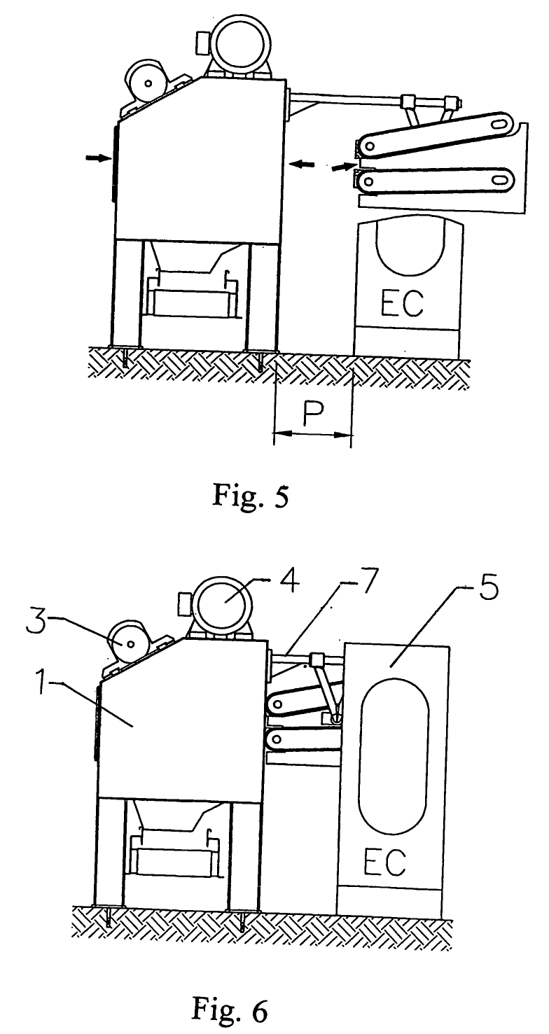

FIG. 5 is a simplified side view of the cutting machine with the access space shown,

FIG. 6 is a simplified side view of the cutting machine with the feeding-compacting arrangement frame being moved adjacently to the main frame,

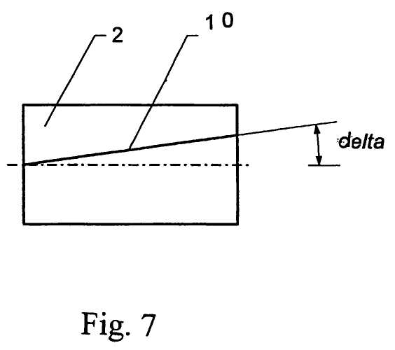

FIG. 7 is a simplified side view of the cutterhead with an inclination angle of the cutting edges of the cutting knives marked.

In the proposed solution the cutting machine comprises a cutting head 2, being a cutterhead (FIG. 3) mounted in a stationary main frame 1, fixed to the floor and rotating in the frame about its horizontal axis, and a frame 5 of a feeding-compressing arrangement, not being permanently fixed to the main frame 1. Rotation of the cutterhead 2 is actuated by an electric motor 4. The frame 5 of the feeding-compressing arrangement forming a stream of the fed material comprise transporters 9 feeding the material into a cutting zone 8 and means for compacting and/or polarizing relative distribution of the fed particles. The feeding-compressing arrangement frame 5 is a movable/adjustable frame, which slides by means of (along) guides 7 placed preferably over the frame 5 to create an access space P.

The main frame 1 of the cutterhead 2 remains stationary (immovable relative to the floor) during operation of the machine as well as during its technological, servicing and/or maintenance handling whereas the rest of the machine, including an immobile lower knife 12 and portions feeding the material into the cutting/comminuting zone, is movable relative to the stationary main frame 1.

The guides 7 situated favourably over the frame 5 allow for direct access from the floor/base level thus allowing for a proper and safe access to the cutting knives 13 as well as to the lower knife 12, installed in the mouthpiece, i.e., the access to the zone of tobacco (material) fed to the cutting zone 8 by the transporters 9.

A distance a between the lower knife 12 edge of the mouthpiece and the surface of a cylinder described by the cutting edges of the cutting knives 13 of the cutterhead is almost zero (FIG. 4).

Furthermore, the cutting machine may be equipped with a device of any suitable design feeding the material to the cutting zone (not shown), the purpose of the device being also to form and compact the stream of tobacco material in the cutting zone 8 to an optimal level for the cutting/comminuting process, the device optionally may transfer suitably directed vibrations to the transported material thus effecting its advantageous for the cutting/comminuting process polarization and more intensive compacting of the material fed to the cutting/comminuting zone.

In the proposed solution transporters 9 transporting tobacco material to the cutting/comminuting zone 8 are belt and/or chain transporters design of which allows placing vibration portions under the upper surface of the belt/chain of the lower conveyor and/or over the lower surface of the belt/chain of the upper conveyor respectively, i.e., inside the lower/upper conveyor in a manner allowing transferring a vector of optimal vibrations, parameters of which may be chosen computationally, in practice being adjusted empirically while they may be different for different kinds of organic materials.

The cutterhead comprises a drum having cutting knives 13 mounted around its periphery, the cutting knives rotating with the rotating drum, the task of the cutting knives is to cut/comminute tobacco material fed by the feeding section, i.e., transporters 9, into the cutting/comminuting zone. A specific feature is that the number of cutting/comminuting knives is chosen so as the number is divisible by 2, preferably by 4, 8 or 16 and so as to ensure full symmetry of the cutting knives relative to two, mutually perpendicular planes of symmetry crossing the horizontal main axis of the drum. It allows for a wide range of adjusting efficiency of the cutting machine in the proposed solution by inserting/removing the cutting knives in such a sequence so as the operating cutting knives 13 are symmetrically arranged relative to the main axis of the drum, leaving equidistant, symmetrical gaps between the cutting edges ensuring thereby constant, smooth technological parameters of cutting/comminuting the material, and a uniform loading of the cutterhead 2 as well as its bearing elements.

In the proposed solution the operational mode, i.e. the sequence of inserting/removing the working knives is 2 or 4 or 8 or 16 thus four levels of direct adjustment of throughput of cutting/comminuting exist.

The cutting knives 13 are arranged symmetrically around the perimeter of the drum of the cutterhead and are slid outside and sharpened continuously during a cutting/comminuting operation so that the cutting edges 10 of cutting knives 13 (FIG. 7) are slightly inclined at an angle delta relatively to the horizontal direction during the cutting/comminuting operation. The inclination angle relatively to the horizontal direction depends on technological requirements for quality parameters of cutting/comminuting and is determined while designing the machine and may be from 0° to 15°, preferably 0° to 10°.

In order to maintain sharpness of cutting edges 10 of cutting knives 13 at optimal level, required by technology of cutting/comminuting, and for maintaining a constant distance of cutting edges 10 of cutting knives 13 from lower knife threshold edge that is stationary (immovable) and placed in the lower part of the mouthpiece, the cutting knives are sharpened by the grinding machine 3, the grinding wheel of which rotates in the direction opposite (backward) relative to the rotation of the cutterhead 2.

Both the geometry of the cutter 13 and the path of this cutter in the cutting/comminuting zone have been modified in such a way that they ensure optimal conditions for cutting/comminuting, wherein parallel to the plane of cutting/comminuting forces occur and wherein disadvantageous forces perpendicular to the plane of cutting/comminuting have been minimized or eliminated.

Moreover, the access to sharp edges of cutting knives 13 from the access space P is automatically covered by specially designed shield elements, this being important for safety reasons.

Moreover, the cutting machine in the presented embodiment has an integral control system EC (electrical cabinet), see FIGS. 5 and 6.

The rotary drum has the diameter of 1000 mm, relative to about 600 mm in standard embodiments, thereby improving cutting parameters such as smoothness of the cutting process, by decreasing peripheral and normal unit forces in the cutting zone relative to a bigger mass of the drum, the forces obtained by increasing the cutter rake angle while decreasing the angle of the cutter blade obtained by increasing the diameter of the cutter drum. It is particularly important to increase optimally the rake angle of the cutter, optimally approaching the manner where the cutting machine is cutting as a guillotine would be cutting, wherein material cutting/splitting forces act in parallel to the plane of splitting. In such a cutting/comminuting process forces normal to the plane of splitting are equal to zero or minimized such that the very disadvantageous effect of “drawing out” of small particles of the material from the cutting zone will not occur or will be minimized.

1. A cutting machine for organic plant materials, especially for tobacco, having a cutterhead mounted in a main frame, and a feeding-compacting arrangement frame, forming a stream of a fed material, comprising transporters feeding the material into a cutting zone, and means for compacting and/or polarizing mutual distribution of fed particles, characterized in that the cutterhead (2) is mounted in the stationary main frame (1), fixed advantageously to the floor, and a feeding-compacting arrangement frame (5) is moved along the horizontal guides (7).

2. A cutting machine according to claim 1, characterized in that the cutting head (2) is a cutterhead with the main axis of rotation being horizontal.

3. A cutting machine according to claim 2, characterized in that the cutterhead is provided with a number of cutting knives (13), symmetrically arranged around its perimeter, the number being divisible by 2, 4, 8 or 16.

4. A cutting machine according to claim 3, characterized in that the cutting knives (13) have cutting edges (10) situated at an angle (delta) relatively to the horizontal direction during the cutting/comminuting operation.

5. A cutting machine according to claim 4, characterized in that the distance (a) between the lower knife (12) edge of the mouthpiece and a surface of a cylinder described by the cutting edges of the cutting knives (13) of the cutterhead is almost zero.

6. A cutting machine according to claim 4, characterized in that the angle (delta) is in the range from 0° to 15°, preferably from 0° to 10°.

7. A cutting machine according to claim 1, characterized in that the guides (7) are placed over the feeding-compacting arrangement frame (5).

8. A cutting machine according to claim 1, characterized in that it is provided with an integral control system (EC).

9. A cutting machine according to claim 1, characterized in that the main frame (1) is provided with shield elements for the cutting edges of the cutting knives (13) on the side of the access space (P).
